(19) United States
(12) Patent Application Publication
(10) Pub. No.: US 2026/0108830 A1
(43) Pub. Date: Apr. 23, 2026

(54) LIQUID FILTRATION DEVICE

(71) Applicant: XIM LLC, Cottonwood Heights, UT (US)

(72) Inventor: Tayler Scharman, Riverton, UT (US)

(73) Assignee: XIM LLC, Cottonwood Heights, UT (US)

(21) Appl. No.: 19/115,093

(22) PCT Filed: Dec. 22, 2023
(86) PCT No.: PCT/US2023/085691

§ 371 Date: Mar. 25, 2025

Related U.S. Application Data
(60) Provisional application No. 63/435,138, filed on Dec. 23, 2022.

(51) Int. Cl. B01D 35/027

(52) U.S. Cl. CPC B01D 35/0276; B01D 2201/0415; B01D 2201/16

(57) ABSTRACT

A cooling and heating liquid filtration device comprising a liquid filtration device comprising a main tank and a second tank wherein the main tank has a first chamber, and the second tank has a second chamber. A filter removably coupled to the second tank. A first piston coupled to the main tank wherein the valve can release a liquid from the main tank into a storage tank through a water tank valve. A cooling or heating system can be coupled to the storage tank. The main tank can be removably coupled to the second tank. The pump can have at least one second piston coupled to it by at least one tube wherein the second piston pushes against the first piston wherein the first and second piston is a mechanical or electrical valve or push piston.

### CROSS REFERENCE

This application claims benefit from currently pending U.S. Provisional Application No. 63/435,138 titled “Cooling and Heating Liquid Filtration Device” and having a filing date of Dec. 23, 2022, and all of which is incorporated by reference herein.

### FIELD OF THE INVENTION

The present specification relates generally to devices for filtering a liquid and more specifically for a system that filters and stores the liquid while it waits to be either heated or cooled within a powder mixing system.

### BACKGROUND OF THE INVENTION

Liquid storage systems are essential in various industries, including food and beverage, pharmaceutical, and chemical industries. These systems are designed to store and manage liquids in a safe and efficient manner. However, traditional liquid storage systems often face challenges in maintaining the quality and temperature of the stored liquid. For instance, the liquid may need to be cooled or heated to a specific temperature for certain applications, and this process must be controlled accurately to prevent any degradation in the quality of the liquid.

For example, food processors are common on the market today and are designed to mix, cut, chop, blend or otherwise process foods and powders. Given the advent of health-conscious individuals, there are people that are prioritizing their eating and drinking habits. As such, people are buying accessories to accompany this healthy lifestyle to help make their food and drinks easier for consumption. Individuals have developed regular fitness regimes that ensure they eat properly, exercise daily and get the proper nutrition for their bodies to recover. Recovery can be assisted by mixing protein and vitamin powders into their diet. These powders are often mixed with food or liquids and are usually consumed in the morning or close to the time of exercise. These liquids are usually heated or cooled depending on the user's preference.

Various products have been developed to assist in mixing these powders in with the liquids. However, they lack the ability to safely filter the liquid and then store the liquid until it is ready to user. The liquid stored in these systems often needs to be filtered to remove any impurities or contaminants. The filtration process is crucial in ensuring the purity and safety of the liquid. However, traditional liquid storage systems often have fixed filters that are difficult to replace, which can lead to inefficiencies in the filtration process. The design of traditional liquid storage systems often lacks flexibility. For example, the storage tank and the filling tank are typically fixed in place, which can make it difficult to clean or maintain the system. Additionally, the valve that controls the release and push of the liquid is often rigid and lacks the ability to selectively direct the liquid to different parts of the system, such as a cooling tank or a heating mechanism.

Therefore, there is a need for an improved liquid storage system that can effectively manage the temperature of the stored liquid, provide efficient filtration, and offer flexibility in its design and operation. Such a system would significantly enhance the storage and management of liquids in various industries.

### BRIEF SUMMARY OF THE INVENTION

Accordingly, the present invention pertains to a liquid storage system that can include a filtration device, a filter, and a valve. The filtration device can comprise a storage tank and a filling tank, with the filling tank being removably coupled to the inside of the storage tank, creating a first chamber in the storage tank and a second chamber in the filling tank. The filter can be removably coupled to the filling tank, and the valve is coupled to the storage tank. The valve can selectively release the liquid allowing for a pump to pull from the storage tank and push the liquid into a cooling tank or through a heating mechanism.

The filling tank has a first end and a second end, with the first end being open and the second end being closed and having a filtration hole. The second end of the filling tank can have a filter holder that allows the filter to be removably coupled to it. The first chamber comprises a ledge which can support the filter and the filling tank. The valve can be coupled to a piston which can close or open when set in place. The storage tank is rotatably coupled to a lid and a handle by a pivot joint. The valve is coupled to the cooling tank or the heating mechanism by at least one tube having a pump that can pull or push the liquid into the cooling tank or the heating mechanism.

The cooling tank can be insulated with at least two walls and comprises a drain wherein the cooling tank has at least one cooling fin coupled to at least one thermal electric cooler. The thermal electric cooler is coupled to a heat sink. The heating mechanism is at least one tube with at least one heating coil coupled to it. The thermal electric cooler and heat sink are covered with a cover with a fan coupled to it which directs air through the cover and away from the heat sink. The thermal electric cooler is a Peltier device.

This invention provides a comprehensive solution for liquid storage and temperature regulation, ensuring the liquid is stored, filtered, and heated or cooled as needed. The system's design allows for easy assembly and disassembly, making maintenance and cleaning more convenient. The use of a thermal electric cooler, particularly a Peltier device, and a heating coil ensures efficient temperature regulation, while the inclusion of a fan helps to manage heat dissipation. The system's design also allows for rotation and easy handling, enhancing its usability.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is a front isometric view of the liquid storage system in accordance to one, or more embodiments;

FIG. 2a is a back view of the liquid storage system in accordance to one, or more embodiments;

FIG. 2b is a cross-sectional view of FIG. 2a of the liquid storage system in accordance to one, or more embodiments;

FIG. 3 is a bottom view of the liquid storage system in accordance to one, or more embodiments;

FIG. 4 is a top view of the liquid storage system in accordance to one, or more embodiments;

FIG. 5a is a exploded front view of the liquid storage system in accordance to one, or more embodiments;

FIG. 5b is a cross sectional view of FIG. 5a of the liquid storage system in accordance to one, or more embodiments;

FIG. 6 is an exploded front isometric view of the liquid storage system in accordance to one, or more embodiments;

FIG. 7a is a front view of the liquid storage system and a heating and cooling system in accordance to one, or more embodiments;

FIG. 7b is a cross-sectional view of FIG. 7b of the liquid storage system and a heating and cooling system in accordance to one, or more embodiments;

FIG. 8 is a front view of the liquid storage system and a heating and cooling system in accordance to one, or more embodiments; and

FIG. 9 is a bottom view of the liquid storage system and a heating and cooling system in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

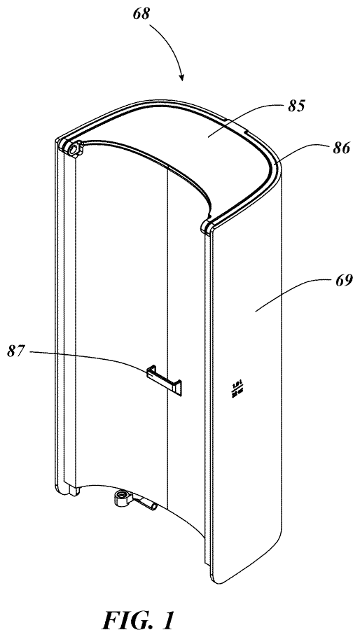

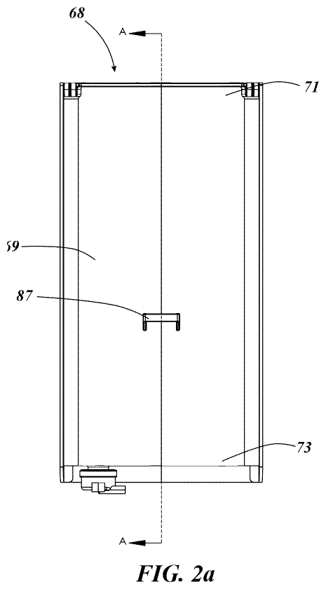

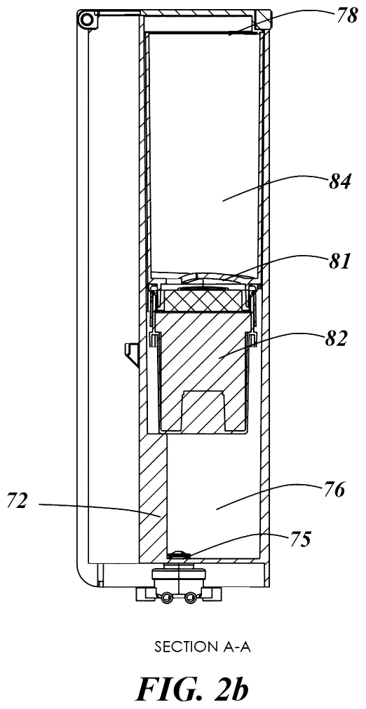

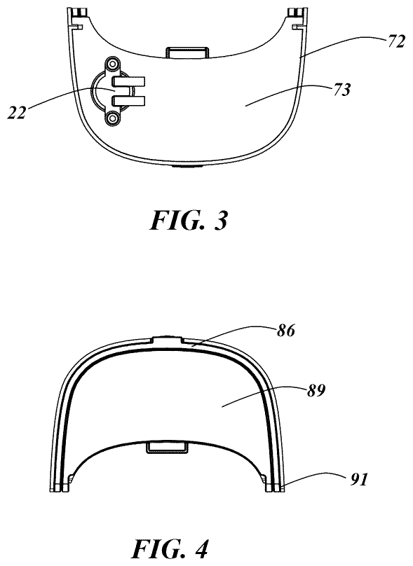

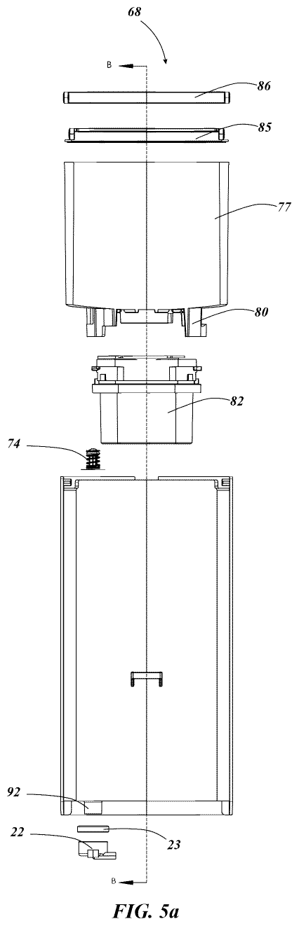

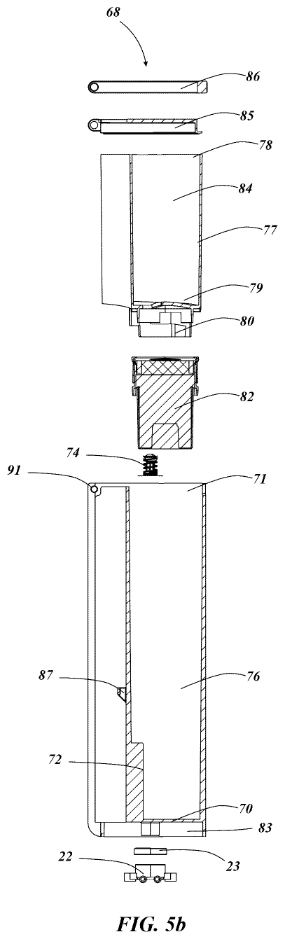

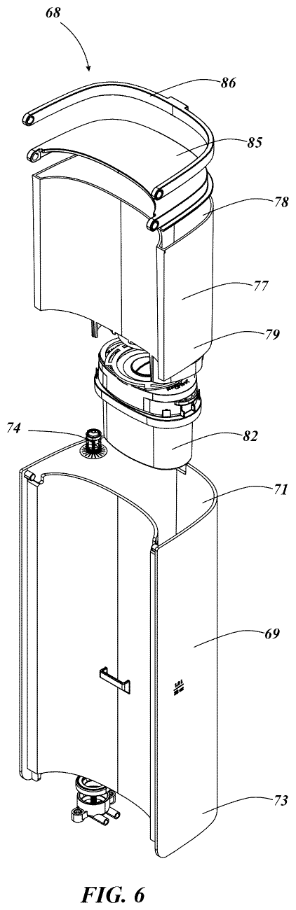

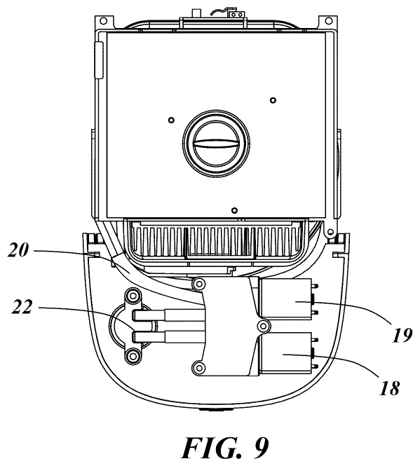

Referring to FIGS. 1-9 a liquid storage system for a powder and liquid mixing system is shown generally at 68. The liquid storage system 68 can comprise a storage tank 69 and a filling tank 77. The filling tank 77 can be removably coupled to the inside of the storage tank 69, creating a storage chamber 76 in the storage tank and a filling chamber 84 in the filling tank. The filling tank 77 can have a first end 78 that is open and a second end 79 that is closed, with a filtration hole 81. The second end 79 of the filling tank 77 can also include a filter holder 80 that allows a filter 82 to be removably coupled to it. The filling tank 77 can be inserted and removably coupled to the storage tank 69 allowing the user to be able to remove and clean both the filling tank and the storage tank. The filling tank 77 can be outer shape can be substantially the same shape as the storage tank's 69 inner shape and can be a loose fit allowing the filling tank to easily be inserted into the storage tank. The filling tank 77 can be a volume that is substantially smaller than the storage tank's 69 volume allowing the liquid to sit in both the filling tank and the storage tank.

The filling tank 77 can have a filtration hole 81 on the filling tank's second end which can be a closed end. The filtration tank's 77 first end can be open allowing a user to put liquid in the filling chamber 84. The filtration hole 81 can allow the liquid to flow through a filter 82 and down into the storage chamber 76 where the liquid can wait until. In certain embodiments, the filtration hole 81 can have a valve on it selectively allowing the liquid within the filling chamber 84 to enter the storage chamber 76 when needed. In embodiments, the filter can be such as, for example, mechanical filter, absorption system, sequestration filters, io exchange filters, reverse osmosis, or the like. The filter 82 can be attached to the filling tank by a filter holder 80 and can be sealed against the filling tank 77 wherein the liquid can only flow through the filter into the storage chamber through the filtration hole 81 and the filter. In certain embodiments the filter 82 can be inside the filling tank 77 and coupled to it by a filtration hole or it can be sealed against the filling tank by at least one tab.

In embodiments, the storage chamber 76 can have a support 72 wherein the support can be abutted up to the filter supporting the filter 82 and the filling tank 77 at a set height from a storage tank's bottom 70 which can be such as, for example, between 1 inch to 10 inches and more preferably 2 inches to 7 inches and still more preferrable 3 inches. The storage chamber 76 can store be such as, for example, between ¼ cup to 40 cups and more preferably 2 cups to 10 cups and still more preferrable 5 cups. The filling chamber 84 can store such as, for example, between ¼ cup to 40 cups and more preferably 2 cups to 10 cups and still more preferrable 5 cups. The storage chamber 76 can store substantially more liquid or substantially less liquid than the filling tank 77. The storage tank 69 can have a pivot joint 91 integral to its first end 71 wherein a lid 85 and a handle 86 can be rotatable attached to the pivot joint covering the filling tank and the storage chamber's first end 71.

The storage tank 69 can have a second end 73 which can be integral to the tank's bottom 70 wherein the second end can extend past the bottom forming a tank support 83 which can support the storage tank when installed into a base. The storage tank 69 can have a bottom 70 that can have a piston hole 75 wherein the piston hole can be coupled to the piston 74. The piston 74 can be coupled to the piston hole by such as, for example, press fit, welded, screwed, adhesive, or the like. The piston 74 can have an O-ring 23 which can seal against the hole or protrusion keeping the liquid from leaking out of the storage chamber 76. The piston 74 can be such as, for example, piston valve, on/off valve, solenoid valve, push valve, check valve, or the like. The piston 74 can be in at least two positions for example, when pushed against the piston can be open allowing the liquid to flow and when not push the piston is closed keeping the liquid within the storage tank 69.

The storage tank 69 can have a hinge 87 coupled to it on the outside or inside of the main tank substantially near the storage tank's second end 73 and can be on the front side of the storage tank where to an external body. The hinge 87 can be such as, for example, magnet, flexible magnet, protrusion, hanger, tab, or the like. In certain embodiments the filling tank 77 can have a guide when inserted into the storage tank 69 that allows the filling tank to stay centered and sealed against the storage tank. The storage tank 69 and the filling tank 77 can be made from the same material or different materials such as, for example, plastics, metals, ceramics, or the like and can be made from one piece or multiple pieces.

The valve 22 can be coupled to at least one pump wherein in the preferred embodiment there at least two pumps a first pump 18 and a second pump 19. The pumps 18 can be such as, for example, micro-pump, centrifugal pump, positive displacement, axial flow or the like. The pumps 18 can be coupled to tubing 20 wherein at least one valve 22 can be coupled to the tubing that runs to the first pump 18 and the second pump 19. The valve 22 can be such as, for example, three-way valve, check valve, two-way valve, gate valve, pressure relief valve, or the like. The valve 22 can be coupled by tubing 20 to either the cooling tank 24 or the heating mechanism 21 by at least one tube having a pump that can pull or push the liquid into the cooling tank or the heating mechanism.

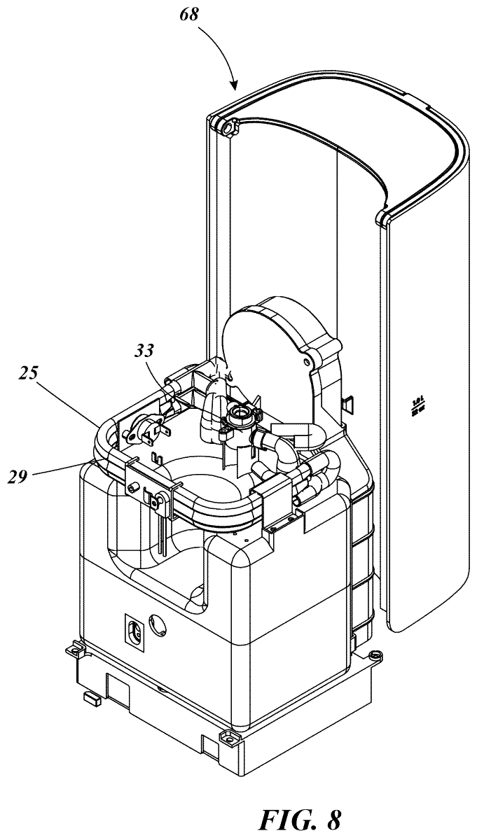

The cooling tank 24 can be insulated with at least two walls and includes a drain 42. The cooling tank 24 can have at least one cooling fin 26 coupled to at least one thermal electric cooler 27, which can be a Peltier device. The thermal electric cooler 27 can be coupled to a heat sink 34 and can be covered with a cover 36 with a fan 38 coupled to it. The fan 38 directs air through the cover 36 and away from the heat sink 34. The heating mechanism 21 can comprise at least one heating coil 25 which can be coupled to at least one heating tube 29 that can bend back around its same path as shown in FIG. 8. The heating mechanism 21 can allows for the efficient heating of the liquid before when it released from the storage tank into the system.

The at least one tube 20 can be coupled to a cooling tank 24 and a heating mechanism 21 wherein a second valve can selectively open and close when a user calls for hot or cold liquid. The cooling tank 24 can be any suitable size or shape but in the preferred embodiment the cooling tank is as shown in FIG. 8. The cooling tank 24 can have a cooling tank hole on at least one of its sides, wherein the preferred embodiment the cooling tank hole is on its top side wherein the hole can be coupled to a second valve 33 which can selectively release hot liquid or cold liquid. The second valve 33 can be coupled to at least one tube 20 which leads to or from the pump 18 wherein in certain embodiments a check valve can be coupled between the tubes keeping the liquid from flowing in the opposite direction towards the storage chamber 76.

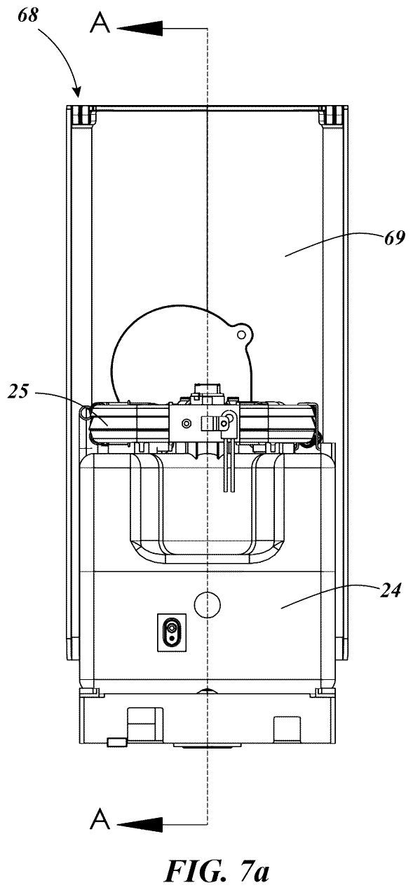

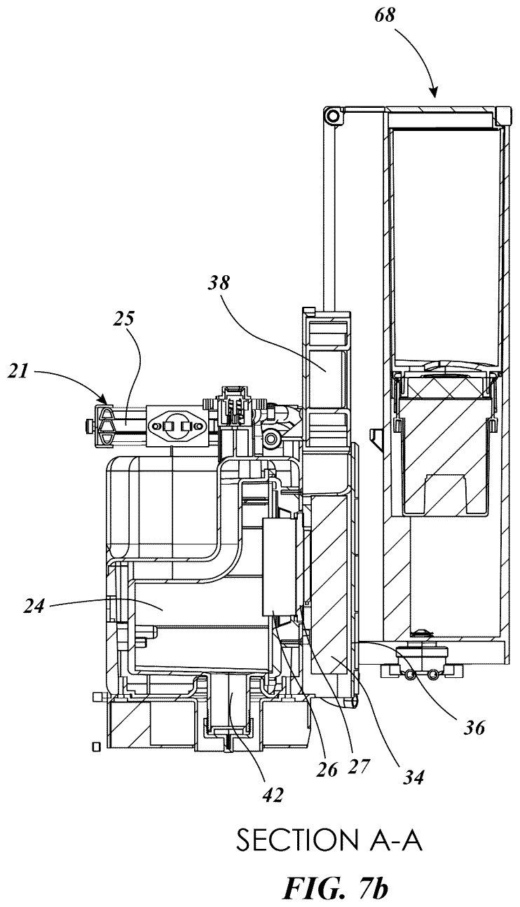

The cooling tank 24 can be coupled to a heatsink 34 wherein the heatsink can be coupled to a thermoelectric cooler, such as a Peltier device (not shown) or cooling blanket, or the like, which can allow for the tank to cool the liquid down to a user specified set temperature. The heatsink 34 can be covered by a heat sink cover 36 wherein the heat sink cover can protect the heatsink and direct the air from a radial fan 38 into the heat sink and through a base plate slot 46 out of the system, cooling the heat sink and wicking away the heat from the thermoelectric cooler. The cooling tank 24 can be shell with an opening on at least one of its sides allowing for the heatsink 34 to be sealed and coupled to the cooling tank 24. The cooling tank 24 can be any suitable shape or size but in the preferred embodiment the shape is as shown in FIG. 7.

The heatsink 34 can be sealed to the cooling tank 24 by such as, for example, adhesive, fastener, RTV, or the like. The heatsink 34 can be such as, for example, bonded heatsink, extruded heat sink, stamped heat sink, forged heat sink, or the like. The temperature of the liquid can be set from at least 33 degrees Fahrenheit to at least 150 degrees Fahrenheit. The liquid can be such as, for example, tap water, distilled water, alkaline water, or the like.

The liquid storage system 68 can provide a versatile and efficient solution for storing and controlling the temperature of liquids. The system's unique design allows for easy removal and replacement of the filter, and the inclusion of both a cooling tank and a heating mechanism ensures that the liquid can be maintained at the desired temperature. The use of a thermal electric cooler and a heat sink further enhances the system's ability to control the temperature of the liquid.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

1. A liquid storage system comprising:
a filtration device comprising a storage tank and a filling tank wherein the filling tank has an open end and a second end and is removably coupled to the inside of the storage tank creating a storage chamber in the storage tank and a filling chamber in the filling tank;
a filter holder extending from the second end allowing a filter to be removably secured to an exterior of the filling tank; and
a valve coupled to the storage tank wherein the valve selectively releases and pushes a liquid from the storage tank into a cooling tank or through a heating mechanism.

2. The liquid storage system of claim 1, wherein the filling tank has filling tank first end and a filling tank second wherein the filling take first end is open and the filling tank second end is closed having a filtration hole.

3. (canceled)

4. The liquid storage system of claim 1, wherein first chamber comprises a ledge which contacts the filter when the filter is coupled to the exterior of the filling tank and the filling tank is in the storage tank.

5. The liquid storage system of claim 1, wherein the valve is coupled to a piston which can close or open when set in place.

6. The liquid storage system of claim 1, wherein storage tank is rotatably couple to a lid and a handle by a pivot joint.

7. The liquid storage system of claim 1, wherein the valve is coupled to the cooling tank or the heating mechanism by at least one tube having a pump that can pull or push the liquid into the cooling tank or the heating mechanism.

8. The liquid storage system of claim 1, wherein the cooling tank is insulated with at least two walls and comprises a drain wherein the cooling tank has at least one cooling fin coupled to at least one thermal electric cooler.

9. The liquid storage system of claim 8, wherein the at least one thermal electric cooler is coupled to a heat sink.

10. The liquid storage system of claim 1, wherein the heating mechanism is at least one tube with at least one heating coil coupled to it.

11. The liquid storage system of claim 9, wherein the thermal electric cooler and heat sink are covered with a cover with a fan coupled to it which directs air through the cover and away from the heat sink.

12. The liquid storage system of claim 8, wherein the thermal electric cooler is a Peltier device.
